(19) United States
(12) Patent Application Publication
(10) Pub. No.: US 2026/0007956 A1
(43) Pub. Date: Jan. 8, 2026

(54) METHOD FOR ADJUSTING SWITCH OF GAME CONTROLLER, GAME CONTROLLER, AND COMPUTER-READABLE STORAGE MEDIUM

(71) Applicant: QANBA USA, LLC, Daly City, CA (US)

(72) Inventors: Jeffrey LYO, Daly City, CA (US); Kai Liu, Daly City, CA (US); Xiang Long Zhong, Shenzhen (CN)

(21) Appl. No.: 19/258,820

(22) Filed: Jul. 2, 2025

(30) Foreign Application Priority Data
Jul. 3, 2024 (CN) 2024108826973

(51) Int. Cl. A63F 13/24

(52) U.S. Cl. CPC A63F 13/24

(57) ABSTRACT

The present disclosure discloses a method for adjusting switches of a game controller, a game controller, and a computer-readable storage medium that stores instructions for performing the same. The method includes: establishing a mapping between a plurality of logical switches and a plurality of physical switches; triggering a first logical switch by using a setting switch to select the first logical switch, triggering a first physical switch mapped with the first logical switch in response to the triggering of the first logical switch; triggering a second physical switch by pressing the second physical switch; exchanging a first function of the first physical switch with a second function of the second physical switch

### CROSS-REFERENCE TO RELATED APPLICATION(S)

The present application claims priority to and the benefit of Chinese Patent Application No. 2024108826973, filed at the China National Intellectual Property Administration on Jul. 3, 2024, the entire disclosure of which is incorporated herein by reference.

### TECHNICAL FIELD

The present disclosure relates to the field of game peripherals, and in particular to a method for adjusting a switch of a game controller, a game controller, and a computer-readable storage medium that stores computer-executable instructions for performing the same.

### BACKGROUND

Competition-level fighting games generally require a special console and a controller. The console may include PS4®, PS5®, Xbox®, etc., and the controller generally may have a universal confirmation switch, a return switch, a jump switch, a joystick to control the movement of a game character in various directions, and/or the like.

The existing way of operating the above console games with the controllers is not playable enough. For example, when controlling the game character with the joystick on the controller, the response time between the moment of using the joystick and the moment that the game character responds may be too long, which is not conducive to provide a good operating experience for a game player, or may even cause the game player to lose the game.

Moreover, the positions of the game switches (e.g., the confirmation switch, the return switch, the jump switch, and/or the joystick) of the above-mentioned controller are usually fixed and may not be adaptively adjusted according to the use requirements or preferences of different game players.

### SUMMARY

An object of the present disclosure is to provide a method for adjusting a switch of a game controller. The method may include adjusting a function of a physical switch on the game controller according to a logical switch mapped to the physical switch to solve the above problem, as well as a game controller and a computer-readable storage medium that stores instructions for performing the same.

The present disclosure achieves the above object with the following technical solutions.

A first aspect of the present disclosure provides a method for adjusting a switch of a game controller, which is a method for adjusting functions of a plurality of physical switches according to a plurality of logical switches. The method may include establishing a mapping (e.g., a one-to-one mapping) between a plurality of logical switches and a plurality of physical switches, triggering a first logical switch by using a setting switch to select the first logical switch, triggering a first physical switch mapped to the first logical switch in response to the triggering of the first logical switch, triggering a second physical switch by pressing the second physical switch, and exchanging a first function of the first physical switch with a second function of the second physical switch.

In the first aspect of the present disclosure, by establishing a one-to-one mapping between the plurality of logical switches and the plurality of physical switches, the plurality of physical switches corresponding to the plurality of logical switches may be triggered by means of triggering the plurality of logical switches. After the first logical switch is triggered, the first physical switch corresponding to the first logical switch to be swapped may be determined. By triggering the second physical switch, the second physical switch to be swapped may also be determined. Thus, the first function of the first physical switch and the second function of the second physical switch may be conveniently swapped or exchanged.

In one or more embodiments, a first indicator light of the first physical switch may be active (e.g., the first indicator light is turned on) in response to the triggering of the first physical switch, a second indicator light of the second physical switch may be active (e.g., the second indicator light is turned on) in response to the triggering of the second physical switch.

In one or more embodiments, the first indicator light and the second indicator light may have the same color.

In one or more embodiments, the method may further include establishing a trigger sequence of the plurality of logical switches, in response to the triggering of the first physical switch, selecting a second logical switch according to the trigger sequence, triggering the second physical switch mapped to the second logical switch in response to the selecting of the second logical switch, triggering a third physical switch in response to the triggering of the second physical switch, wherein a third logical switch mapped to the third physical switch is next to the second logical switch mapped to the second physical switch in the trigger sequence, and exchanging the second function of the second physical switch with a third function of the third physical switch.

In one or more embodiments, the method may further include, in response to the triggering of the second physical switch, determining whether the first function of the first physical switch needs to be exchanged with the second function of the second physical switch, and in response to a determination that the first function of the first physical switch does not need to be swapped with the second function of the second physical switch, triggering the third logical switch according to the trigger sequence.

In one or more embodiments, the game controller may include an indicator area and an operation area, where the plurality of logical switches may be arranged in the indicator area, and the plurality of physical switches may be arranged in the operation area.

In one or more embodiments, the indicator area may include the setting switch and a display unit, the display unit may be configured to display the plurality of logical switches, and the plurality of logical switches may be triggered by triggering the setting switch.

In one or more embodiments, the plurality of physical switches may include a plurality of common switches and a plurality of blank switches, and each of the plurality of common switches may be mapped with a corresponding logical switch of the plurality of logical switches respectively.

A second aspect of the present disclosure provides a game controller. The game controller may include a memory, a processor, and a computer program stored in the memory and executable on the processor. When executing the computer program, the processor implements the method set forth in the first aspect of the present disclosure.

A third aspect of the present disclosure provides a computer-readable storage medium, the computer-readable storage medium stores computer executable instructions, when the computer executable instructions are executed by a processor, the computer executable instructions prompt the processor to execute the method set forth in the first aspect of the present disclosure.

The benefits of the present disclosure may include providing a method for adjusting switches of a game controller, which adjusts the functions of physical switches according to their corresponding logical switches, as well as a game controller and a computer-readable storage medium that may implement the method.

### BRIEF DESCRIPTION OF THE DRAWINGS

To more clearly illustrate the technical solutions in one or more embodiments of the present disclosure or the existing technology, the following will briefly introduce the drawings needed for the description of the embodiments or the existing technology. The drawings described below are only some embodiments of the present disclosure. For a person of ordinary skill in the art, other drawings may be obtained based on these drawings without creative efforts.

FIG. 1 is a diagram of an example game controller, according to one or more embodiments of the present disclosure.

FIG. 2 is a flow chart of an example method, according to one or more embodiments of the present disclosure.

1. game controller; 10. indicator area; 20. operation area; 30. function area; 40. support area; 11. setting switch; 12. display unit; 13. factory reset switch.

### DETAILED DESCRIPTION

In order to make the objects, technical solutions and advantages of the present disclosure clear, the technical solutions of the present disclosure will be described in detail below. The embodiments described herein are only some examples of the embodiments of the present disclosure. Based on the example embodiments of the present disclosure, all other embodiments or implementations obtained by a person of ordinary skill in the art without undue efforts should fall within the scope of protection of the present disclosure.

The first aspect of the present disclosure provides a method for adjusting a switch of a game keyboard or game controller (hereinafter sometimes referred to as a switch adjustment method, or the method), which is a method for adjusting the functions of a plurality of physical switches arranged on the game controller according to the plurality of logical switches. In one or more embodiments, the method for adjusting the switch of the game controller may also be referred to as a method for adjusting a switch of a planar game controller, a method for swapping a function of a switch of the planar game controller, a switch adjustment method, and/or the like. For example, a planar game controller may be a controller having a plurality of switches arranged along a planar surface. In some embodiments, the game controller may be a three-dimensional controller having at least one switch not on the same planar surface as another switch, such as a controller with a joystick and/or an arcade controller and/or a gamepad.

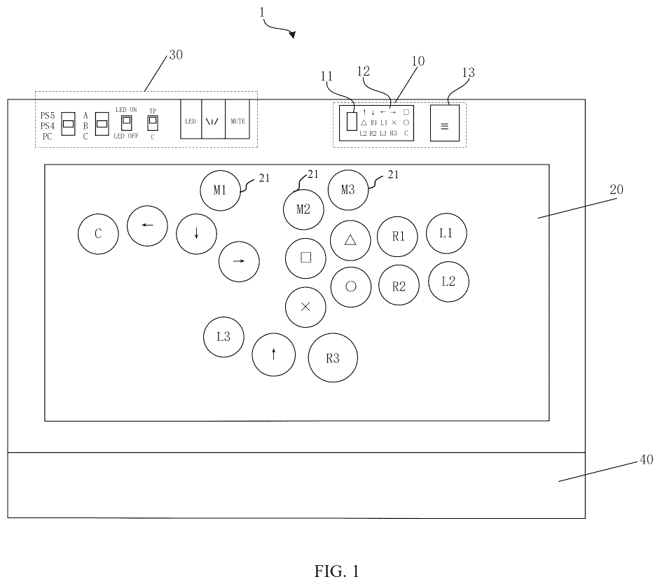

FIG. 1 is a diagram of an example game controller, according to one or more embodiments of the present disclosure.

A game controller 1 may include an indicator area 10, an operation area 20, a function area 30, and a support area 40. The indicator area 10 may include a setting switch 11, a plurality of logical switches, a display unit 12, and a factory reset switch 13. The plurality of the logical switches may be used to quickly adjust a function of a physical switch in the operation area 20, instead of using a game console or other computers to adjust the function of the operation area 20. The operation area 20 may include a plurality of physical switches for the user to execute corresponding functions. For example, the operation area 20 may include a “Δ” (triangle) physical switch that may correspond to a “jump” function for a character in a game. When the user presses the “Δ” (triangle) physical switch in the operation area 20, the “jump” function may be executed in the game to make the character jump. The plurality of physical switches in the operation area 20 may be mapped to the plurality of logical switches in the indicator area 10 respectively.

The function area 30 may include a plurality of function switches to adjust a console type, a game switch mode, an indicator light mode, an audio mode (e.g., mute), and/or the like. For example, a user may select the console type, such as PS5®, PS4®, personal computer (PC), etc., for adaptation. In the function area 30, the user may also select whether to turn on the indicator light or not. If the indicator light needs to be turned on, select “LED ON”, and likewise, if the indicator light needs to be turned off, select “LED OFF”. In one or more embodiments, if the user selects “LED ON”, the indicator lights of all the physical switches in the operation area 20 will be turned on. The indicator light of the physical switches in the operation area 20 may be a first color (e.g., a color of white). When a physical switch in the operation area 20 is triggered (e.g., by its corresponding logical switch in the indicator area 10), the indicator light of the physical switch may be lit up with a second color (e.g., a color of red) to represent that the physical switch is triggered.

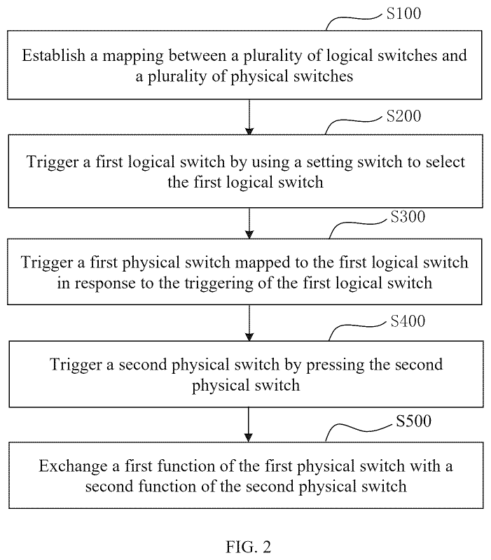

In one or more embodiments, the “A”, “B”, and “C” symbols in the function area 30 may represent a game switch mode including a corresponding switch mapping. For example, “A” represents a default switch mapping, e.g., the default switch mapping shown in the operation area 20 in FIG. 2, “B” and “C” represent two other switch mappings (e.g., “B” may represent a switch mapping with one switch adjustments, and “C” may represent a switch mapping with two switch adjustments). By selecting “A”, “B”, or “C”, the user may select a corresponding game switch mode with a suitable switch mapping according to their performance and/or operation. Thus, the user experience may be improved.

The support area 40 may be utilized to support the user's hand or wrist when they use the game controller 1 to improve the user experience.

In one or more embodiments, the display unit 12 in the indicator area 10 may be used to display the plurality of logical switches, and the plurality of logical switches may be triggered by the setting switch 11. Each of the plurality of logical switches in the indicator area 10 may correspond to a corresponding physical switch of the plurality of physical switches in the operation area 20. For example, a “↑” logical switch in the indicator area 10 may correspond to a “↑” physical switch in the operation area 20. If (e.g., when) the user needs to make an adjustment to change which physical switch in the operation area 20 performs the “↑” function, the user may use the setting switch 11 and the “↑” logical switch in the indicator area 10 to initiate the switch adjustment. For example, the user may press the setting switch 11 to select a corresponding logical switch that the user intends to adjust, and when the logical switch is selected (e.g., triggered), its corresponding physical switch in the operation area 20 will be subsequently triggered. The factory reset switch 13 may be used to restore the original setting of the game controller 1. For example, the game controller 1 may be restored to an initial switch state by pressing the factory reset switch 13. In this way (e.g., resetting the game controller 1 to the initial switch state that is without any switch adjustments by utilizing the factory reset switch 13), the user would not be confused by the switch adjustments made previously.

In one or more embodiments, the plurality of physical switches in the operation area 20 may include a plurality of common switches and a plurality of blank switches. The plurality of common switches may be mapped one-to-one with the plurality of logical switches in the indicator area 10. For example, the one-to-one mapping herein may indicate that each of the common switches in the operation area 20 corresponds to one of the logical switches in the indicator area 10. Likewise, each of the logical switches corresponds to one of the common switches, and the common switch in the operation area 20 may be triggered accordingly by triggering the corresponding logical switch in the indicator area 10. For example, the “∘” (circle) logical switch in the indicator area 10 may correspond to the “∘” (circle) common switch in the operation area 20. The plurality of blank switches 21 (e.g., M1, M2, and M3 switches shown in FIG. 1) may be used for additional operations (e.g., adding a new function to a blank switch and/or switching an existing function from a common switch to a blank switch).

In one or more embodiments, a number of the plurality of logical switches in the indicator area 10 may be 15, a number of the plurality of common switches in the operation area 20 may be 15, and a number of the plurality of blank switches may be 3.

Referring back to FIG. 1, in one or more embodiments, the operation area 20 shows 15 common switches and 3 blank switches. In some embodiments, the 15 common switches may include switches for four directions including a “↑” (up) common switch, a “↓” (down) common switch, a “←” (left) common switch, and a “→” (right) common switch, a “L1” common switch, a “R1” common switch, a “L2” common switch, a “R2” common switch, a “L3” common switch, a “R3” common switch, a “C” common switch, a “□” (square) common switch, a “∘” (circle) common switch, a “Δ” (triangle) common switch, and a “x” (“X” or cross) common switch. In some embodiments, the common switches including the “L1” common switch, the “R1” common switch, the “L2” common switch, the “R2” common switch, the “L3” common switch, the “R3” common switch, the “C” common switch, the “□” (square) common switch, the “∘” (circle) common switch, the “Δ” (triangle) common switch, and the “x” (“X” or cross) common switch may be a confirmation switch, a return switch, a jump switch, and/or the like. For example, the “C” common switch may be used to execute the function of confirmation. If (e.g., when) the user selects a character in the game, the user may press the “C” common switch to confirm the selection. In some embodiments, for different consoles (such as PS5®, PS4® PC, and/or the like), the 11 common switches may have different functions other than the functions listed above.

In one or more embodiments, the operation area 20 may also be provided with other numbers of common switches and blank switches, which may be adaptively adjusted according to different console functions and user requirements.

In one or more embodiments, the 15 common switches in the operation area 20 may correspond to the 15 logical switches in the indicator area 10 respectively. For example, the 15 common switches and the 15 logical switches may form a one-to-one mapping (e.g., a mapping that indicates a plurality of common switches and their corresponding logical switches), and by triggering one of the 15 logical switches, a corresponding common switch may be triggered accordingly.

In one or more embodiments, a processor may be provided in the game controller 1, and the processor may be utilized to receive trigger instructions for the indicator switches in the indicator area 10 and the physical switches in the operation area 20 and implement the switch adjustment.

Specifically, a method for initiating/triggering the switch adjustment of the present disclosure will be described below with reference to FIG. 1.

In one or more embodiments, for triggering a specific logical switch, the indicator area 10 may be active (e.g., the display unit 12 is turned on) by pressing the setting switch 11 for a period of time (e.g., three seconds). Then the user may select a specific logical switch by pressing the setting switch 11 quickly for specific times. For example, as shown in FIG. 1, a trigger sequence of the logical switches in the indicator area 10 (e.g., reading from left to right and from the first row to the third row) is the “↑” (up) logical switch, the “↓” (down) logical switch, the “←” (left) logical switch, the “→” (right) logical switch, the “□” (square) logical switch, the “Δ” (triangle) logical switch, the “R1” logical switch, the “L1” logical switch, the “x” (“X” or cross) logical switch, the “∘” (circle) logical switch, the “L2” logical switch, the “R2” logical switch, the “L3” logical switch, the “R3” logical switch, and the “C” logical switch in order. If the user needs to select/trigger the “←” (left) logical switch in the indicator area 10, the user may press the setting switch 11 for three seconds to active the indicator area 10 first, and then press the setting switch 11 quickly three times to select the “←” (left) logical switch, i.e., the third logical switch in the trigger sequence of the logical switches in the indicator area 10. In other words, the user may press/click the setting switch 11 for a number of times corresponding to the order of a specific logical switch in the trigger sequence of the logical switches. In one or more embodiments, the game controller 1 may be returned to the last operation (e.g., a gaming mode) by double-clicking the setting switch 11 after the switch adjustment (e.g., pressing the setting switch 11 quickly for two times).

Furthermore, a method for implementing the switch adjustment of the present disclosure will be described below with reference to FIG. 1. One or more embodiments will illustrate how to exchange/swap the functions between two physical switches, e.g., rearranging the function of the “↑” physical switch to the “C” physical switch.

In one or more embodiments, for exchanging the functions between the “↑” physical switch and the “C” physical switch, the user may select a specific logical switch using the method for initiating/triggering the switch adjustment described above. For example, a trigger instruction for triggering the switch adjustment may include pressing the setting switch 11 for a period of time for activating the indicator area 10 and pressing the setting switch 11 for a number of times to select a specific logical switch based on the order of the specific logical switch in the trigger sequence. If (e.g., when) the “↑” logical switch in the indicator area 10 is triggered, its corresponding “↑” physical switch in the operation area 20 is triggered accordingly with a red indicator light on, and then by pressing the “C” physical switch in the operation area 20 quickly for one time to select the “C” physical switch with a red indicator light on, the function of the “↑” physical switch may then be exchanged with the function of the “C” physical switch. As a result, the computer program in the processor may automatically exchange/swap the functions of the “↑” physical switch with the “C” physical switch. In some embodiments, such exchange/swap setting (e.g., the steps to exchange/swap the functions of the “↑” physical switch and the “C” physical switch) may be archived by pressing and holding the setting switch 11 for a period of time (e.g., three seconds).

In one or more other embodiments, for exchanging the functions between the “↑” physical switch and the “C” physical switch, steps to initiate exchanging the functions of the “↑” physical switch and the “C” physical switch may be the same as described above. For example, the trigger instruction may be pressing the setting switch 11 one time, pressing the “↑” logical switch in the indicator area 10, and triggering the “↑” physical switch in the operation area 20 accordingly. When the “↑” logical switch in the indicator area 10 is triggered, its corresponding “↑” physical switch in the operation area 20 is triggered accordingly with a red indicator light on. Originally, the processor should have automatically output the trigger instruction according to the trigger sequence to trigger the “↓” physical switch in the operation area 20 with the red indicator light on, because the “↓” physical switch corresponds to the “↓” logical switch which is next to the “↑” logical switch in the trigger sequence in the indicator area 10. Instead, in this embodiment that the user chooses to swap the functions between the “↑” physical switch and the “C” physical switch, the user may press/click the setting switch 11 fourteen times to select the “C” logical switch in the indicator area 10 after the “↑” logical switch in the indicator area 10 is triggered (e.g., triggering the “C” logical switch by pressing the setting switch for specific times instead of triggering the “↓” logical switch based on the trigger sequence), which makes the “C” physical switch in the operation area 20 flash the red indicator light. Simultaneously, the processor may automatically output the trigger instruction according to the trigger sequence, so that the “↑” physical switch in the operation area 20, which corresponds to the “↑” logical switch next to the “C” logical switch in the indicator area 10, may flash the red indicator light. The user may then press/click the “↑” physical switch in the operation area 20 to change the red indicator light from flashing to always on. In response to the selection, the computer program in the processor may change the function of the “↑” physical switch with the function of the “C” physical switch. In some embodiments, such switch adjustment (e.g., the steps to exchange/swap the function of the “↑” physical switch with the function of the “C” physical switch) may be archived by pressing and holding the setting switch 11 for a period of time (e.g., three seconds).

FIG. 2 is a flow chart of an example method according to one or more embodiments of the present disclosure.

Referring to FIGS. 1 and 2, the method may include step S100: establishing a mapping between a plurality of logical switches and a plurality of physical switches. The mapping herein may refer to that each logical switch in the indicator area 10 may correspond to a physical switch among the plurality of physical switches in the operation area 20. By triggering a logical switch, the corresponding physical switch may be triggered accordingly.

In one or more embodiments, the method may include step S200: triggering a first logical switch by using a setting switch to select the first logical switch. For example, the first logical switch may be triggered by pressing the setting switch 11 for a period of time (e.g., pressing the setting switch for three seconds) to activate the indicator area 10 and then pressing the setting switch 11 for specific times to select the first logical switch. For example, if the first logical switch is the fourth logical switch in the trigger sequence among the plurality of logical switches, the user may press the setting switch 11 four times to select the first logical switch and to trigger the first logical switch.

In one or more embodiments, the method may include step S300: triggering a first physical switch mapped to the first logical switch in response to the triggering of the first logical switch. For example, the first physical switch may be triggered based on the triggered first logical switch which is mapped to the first physical switch.

In one or more embodiments, the method may include step S400: triggering a second physical switch by pressing the second physical switch. For example, the user may press the second physical switch to cause the second physical switch to output a trigger instruction, which is used to trigger the exchange of the function with the first physical switch.

In one or more embodiments, the method may include step S500: exchanging a first function of the first physical switch with a second function of the second physical switch.

In the present disclosure, a function of the physical switch corresponds to a physical position of the physical switch in the initial switch state. The exchanging/swapping of the functions of the physical switches of the present disclosure may refer to exchanging a first function of a first physical switch with a second function of a second physical switch, such that the first physical switch may execute the second function, and the second physical switch may execute the first function. In this way, instead of exchanging/swapping the actual physical positions of the physical switches to adjust their functions, the method for adjusting a switch of a game controller of the present disclosure may conveniently change/adjust the function of a physical switch of the game controller.

In the first aspect of the present disclosure, by establishing a one-to-one mapping between the plurality of logical switches and the plurality of physical switches, the physical switches corresponding to the logical switches may be triggered by means of triggering the plurality of logical switches. For example, after the first logical switch is triggered, the first physical switch corresponding to the first logical switch to be adjusted/swapped may be triggered/determined. By triggering the second physical switch, the second physical switch to be adjusted may also be triggered/determined. Thus, the function of the first physical switch and the function of the second physical switch may be conveniently exchanged/swapped.

In one or more embodiments, when the first physical switch mapped to the first logical switch is selected according to the trigger instruction of the first logical switch, the first indicator light of the first physical switch may be active (e.g., the first indicator is turned on).

In one or more embodiments, when the second physical switch is triggered, the second indicator light of the second physical switch may be active (e.g., the second indicator is turned on).

In one or more embodiments, the first indicator light and the second indicator light have the same color. In one or more embodiments, the first indicator light and the second indicator light may be always on or flashing. In one or more embodiments, colors of the first indicator light and the second indicator light may be red, blue, green, and the like.

In one or more embodiments, a trigger sequence of the plurality of logical switches may be pre-established.

In one or more embodiments, the method may further include step S210: establishing a trigger sequence of the plurality of logical switches, in response to the triggering of the first physical switch, selecting a second logical switch according to the trigger sequence, triggering the second physical switch mapped to the second logical switch in response to the selecting of the second logical switch, triggering a third physical switch in response to the triggering of the second physical switch, where a third logical switch mapped to the third physical switch is next to the second logical switch mapped to the second physical switch in the trigger sequence; and
exchanging the second function of the second physical switch with a third function of the third physical switch. For example, after receiving the trigger instruction of the first logical switch (e.g., step 200) and triggering the first physical switch mapped to the first logical switch (e.g., step 300), step S210 may be executed.

In one or more embodiments, the trigger sequence may be a default sequence for triggering pre-set physical switches. For example, the trigger sequence (e.g., the default sequence) established for the logical switches for four directions may be: the “↑” (up) logical switch, the “↓” (down) logical switch, “←” (left) logical switch, “→” (right) logical switch. After the first logical switch (e.g., the “↑” logical switch) is triggered, the second logical switch (e.g., the “↓” (down) logical switch) and its corresponding second physical switch (e.g., the “↓” (down) physical switch) may be automatically triggered.

In one or more embodiments, the method may further include step S310: in response to the triggering of the second physical switch, determining whether the first function of the first physical switch needs to be exchanged with the second function of the second physical switch, and in response to a determination that the first function of the first physical switch does not need to be swapped with the second function of the second physical switch, triggering the third logical switch according to the trigger sequence. In some embodiments, if a determination indicates that there is no need to exchange/swap the function of the first physical switch with the function of the second physical switch, the method may further include a step of triggering the third logical switch according to the trigger sequence. In some embodiments, if a determination indicates that there is a need to swap the first function of the first physical switch with the second function of the second physical switch and/or the third physical switch, the method may further include a step of executing step S210 or step S400.

In one or more embodiments, step S300 to step S400 may be repeated to select a specific logical switch or a specific physical switch to be triggered.

The second aspect of the present disclosure may further provide a game controller, the game controller may include a memory, a processor, and a computer program stored in the memory and executable on the processor. When executing the computer program, the processor implements the method set forth in the first aspect of the present disclosure.

In some embodiments, the memory may store the trigger sequence as described above.

The third aspect of the present disclosure may further provide a computer-readable storage medium, the computer-readable storage medium stores computer executable instructions, when the computer executable instructions are executed by a processor, the computer executable instructions prompt the processor to execute the method set forth in the first aspect of the present disclosure.

The benefits of the present disclosure include providing a method for adjusting a function of a physical switch on a game controller according to its corresponding logical switch and another physical switch, as well as a game controller and a computer-readable storage medium. In this way, by means of adjusting the function of the physical switch, it is possible to adapt to the operation habits and operating feel for different users and improve the user experience for the users.

The above are merely some specific embodiments of the present disclosure, but the scope of protection of the present disclosure is not limited thereto. A person skilled in the art may easily think of changes or substitutions within the technical scope disclosed in the present disclosure, which should be covered within the scope of protection of the present disclosure. Therefore, the scope of protection of the present disclosure shall be determined by the scope of protection of the claims and equivalents thereof.

What is claimed is:

1. A method for adjusting a switch of a game controller, comprising:
establishing a mapping between a plurality of logical switches and a plurality of physical switches;
triggering a first logical switch by using a setting switch to select the first logical switch;
triggering a first physical switch mapped to the first logical switch in response to the triggering of the first logical switch;
triggering a second physical switch by pressing the second physical switch; and
exchanging a first function of the first physical switch with a second function of the second physical switch.

2. The method of claim 1, wherein a first indicator light of the first physical switch is active in response to the triggering of the first physical switch, a second indicator light of the second physical switch is active in response to the triggering of the second physical switch.

3. The method of claim 2, wherein the first indicator light and the second indicator light have the same color.

4. The method of claim 1, further comprising:
establishing a trigger sequence of the plurality of logical switches;
in response to the triggering of the first physical switch, selecting a second logical switch according to the trigger sequence;
triggering the second physical switch mapped to the second logical switch in response to the selecting of the second logical switch;
triggering a third physical switch in response to the triggering of the second physical switch, wherein a third logical switch mapped to the third physical switch is next to the second logical switch mapped to the second physical switch in the trigger sequence; and
exchanging the second function of the second physical switch with a third function of the third physical switch.

5. The method of claim 4, further comprising:
in response to the triggering of the second physical switch, determining whether the first function of the first physical switch needs to be exchanged with the second function of the second physical switch; and
in response to a determination that the first function of the first physical switch does not need to be swapped with the second function of the second physical switch, triggering the third logical switch according to the trigger sequence.

6. The method of claim 1, wherein the game controller comprises an indicator area and an operation area, wherein the plurality of logical switches is arranged in the indicator area, and the plurality of physical switches is arranged in the operation area.

7. The method of claim 6, wherein the indicator area comprises the setting switch and a display unit, the display unit is configured to display the plurality of logical switches, and the plurality of logical switches is triggered by triggering the setting switch.

8. The method of claim 6, wherein the plurality of physical switches comprises a plurality of common switches and a plurality of blank switches, and each of the plurality of common switches is mapped with a corresponding logical switch of the plurality of logical switches respectively.

9. A game controller, comprising: a memory, a processor, and a computer program stored in the memory and executable on the processor, when executing the computer program, the processor implements a method comprising:
establishing a mapping between a plurality of logical switches and a plurality of physical switches;
triggering a first logical switch by using a setting switch to select the first logical switch;
triggering a first physical switch mapped to the first logical switch in response to the triggering of the first logical switch;
triggering a second physical switch by pressing the second physical switch; and
exchanging a first function of the first physical switch with a second function of the second physical switch.

10. The game controller of claim 9, wherein a first indicator light of the first physical switch is active in response to the triggering of the first physical switch, a second indicator light of the second physical switch is active in response to the triggering of the second physical switch.

11. The game controller of claim 10, wherein the first indicator light and the second indicator light have the same color.

12. The game controller of claim 9, wherein the method further comprises:
establishing a trigger sequence of the plurality of logical switches;
in response to the triggering of the first physical switch, selecting a second logical switch according to the trigger sequence;
triggering the second physical switch mapped to the second logical switch in response to the selecting of the second logical switch;
triggering a third physical switch in response to the triggering of the second physical switch, wherein a third logical switch mapped to the third physical switch is next to the second logical switch mapped to the second physical switch in the trigger sequence; and
exchanging the second function of the second physical switch with a third function of the third physical switch.

13. The game controller of claim 12, wherein the method further comprises:
in response to the triggering of the second physical switch, determining whether the first function of the first physical switch needs to be exchanged with the second function of the second physical switch; and
in response to a determination that the first function of the first physical switch does not need to be swapped with the second function of the second physical switch, triggering the third logical switch according to the trigger sequence.

14. The game controller of claim 9, comprising an indicator area and an operation area, wherein the plurality of logical switches is arranged in the indicator area, and the plurality of physical switches is arranged in the operation area.

15. The game controller of claim 14, wherein the indicator area comprises the setting switch and a display unit, the display unit is configured to display the plurality of logical switches, and the plurality of logical switches is triggered by triggering the setting switch.

16. The game controller of claim 14, wherein the plurality of physical switches comprises a plurality of common switches and a plurality of blank switches, and each of the plurality of common switches is mapped with a corresponding logical switch of the plurality of logical switches respectively.

17. A computer-readable storage medium, wherein the computer-readable storage medium stores computer executable instructions, when the computer executable instructions are executed by a processor, the computer executable instructions prompt the processor to execute a method comprising:
establishing a mapping between a plurality of logical switches and a plurality of physical switches;
triggering a first logical switch by using a setting switch to select the first logical switch;
triggering a first physical switch mapped to the first logical switch in response to the triggering of the first logical switch;
triggering a second physical switch by pressing the second physical switch; and
exchanging a first function of the first physical switch with a second function of the second physical switch.

18. The computer-readable storage medium of claim 17, wherein a first indicator light of the first physical switch is active in response to the triggering of the first physical switch, a second indicator light of the second physical switch is active in response to the triggering of the second physical switch.

19. The computer-readable storage medium of claim 17, wherein the method further comprises:
establishing a trigger sequence of the plurality of logical switches;
in response to the triggering of the first physical switch, selecting a second logical switch according to the trigger sequence;
triggering the second physical switch mapped to the second logical switch in response to the selecting of the second logical switch;
triggering a third physical switch in response to the triggering of the second physical switch, wherein a third logical switch mapped to the third physical switch is next to the second logical switch mapped to the second physical switch in the trigger sequence; and
exchanging the second function of the second physical switch with a third function of the third physical switch.

20. The computer-readable storage medium of claim 19, wherein the method further comprises:
in response to the triggering of the second physical switch, determining whether the first function of the first physical switch needs to be exchanged with the second function of the second physical switch; and
in response to a determination that the first function of the first physical switch does not need to be swapped with the second function of the second physical switch, triggering the third logical switch according to the trigger sequence
